(19) United States
(12) Patent Application Publication
(10) Pub. No.: US 2011/0103606 A1
(43) Pub. Date: May 5, 2011

(54) MODULAR HEADPHONE SYSTEM

(75) Inventor: Michael W. Silber, Simi Valley, CA (US)

(73) Assignee: Harman International Industries, Incorporated, Northridge, CA (US)

(21) Appl. No.: 12/609,791

(22) Filed: Oct. 30, 2009

(51) Int. Cl. H04R 1/10

(52) U.S. Cl. 381/74

(57) ABSTRACT

A modular headphone system includes an ear-mountable speaker, an audio signal-carrying line coupled to the ear-mountable speaker, and an electrical connector coupled to the audio signal-carrying line. The electrical connector is configured for electrically coupling to a plurality of different types of audio signal-carrying devices. The electrical connector may include a quick disconnect feature configured for securing the electrical connector to the audio signal-carrying device. A modular audio system includes a headphone system and an audio signal-carrying device coupled to the headphone system. The audio signal-carrying device may be disconnected from the headphone system, and another audio signal-carrying device of a different type may be coupled to the headphone system.

### BACKGROUND OF THE INVENTION

1. Field of the Invention

This invention relates to a modular headphone system that is able to be quickly and easily connected to a plurality of different types of audio sources and audio signal-carrying devices.

2. Related Art

Many different types of audio sources such as, for example, stereos, radios, CD or DVD players, MP3 devices, telephones, and the like often provide an electrical connection site adapted for coupling to a headphone set (e.g., ear phones, ear buds, and the like). A given headphone set may in some instances be compatible for connection to more than one type of audio source. For example, a given headphone set may be unplugged from the CD player and subsequently plugged into an MP3 player. In each case, however, the resulting headphone/audio playback system is fixed and cannot be reconfigured or modified with additional or alternative devices and accessories that would provide other features or functions desired by the user. As a consequence, for example, if the user of an MP3 player wired to a headphone set would instead like to listen to audio playback in a wireless fashion, the user must purchase a new MP3 player having wireless capability as well as a new wireless headphone set. As another example, if the user of an MP3 player wired to a headphone set would also like to operate a telephone with a headphone set, the user must purchase a new headphone set that is specifically adapted for use in conjunction with the telephone. Accordingly, existing headphone sets generally lack a universal compatibility with different types of audio sources and other audio-related devices and accessories.

Therefore, there is a need for providing a modular headphone system in which the same headphone or pair of headphones is capable of being connected to a variety of different types of audio sources and audio-related devices and accessories. There is also a need for providing a modular headphone system may be utilized in a wide variety of different audio system configurations.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a modular headphone system includes an ear-mountable speaker, an audio signal-carrying line coupled to the ear-mountable speaker, and an electrical connector coupled to the audio signal-carrying line. The electrical connector is configured for electrically coupling to a plurality of different types of audio signal-carrying devices. The electrical connector may include a quick disconnect feature configured for securing the electrical connector to the audio signal-carrying device.

The types of audio signal-carrying devices that may be coupled to the electrical connector of the modular headphone system may include, for example, an audio source, a signal splitting device, a wireless interface, a music/ambient mixing device, a noise cancelling device, a microphone, an elongated conductor including an in-line microphone, an adapter configured for coupling to a telephony device, an elongated electrical conductor including a pair of opposing electrical connectors, and others, and combinations of two or more of the foregoing.

According to another implementation, a modular audio system includes a headphone system and an audio signal-carrying device. The headphone system includes an ear-mountable speaker, an audio signal-carrying line coupled to ear-mountable speaker, and an electrical connector coupled to the audio signal-carrying line. The audio signal-carrying device is electrically coupled to the electrical connector. The electrical connector may include a quick disconnect feature. The audio signal-carrying device may be secured to the electrical connector via the quick disconnect feature.

According to another implementation, the audio system further includes an audio source coupled to the first audio signal-carrying device.

According to another implementation, the audio system further includes a second audio signal-carrying device electrically coupled to the first audio signal-carrying device.

According to another implementation, the audio system further includes an audio source coupled to the second audio signal-carrying device.

According to another implementation, a method for coupling a modular headphone system to an audio signal-carrying device includes selecting an audio signal-carrying device from one of a plurality of different types of audio signal-carrying devices. An electrical connector of the modular headphone system is placed in signal communication with the selected audio signal-carrying device. The signal communication is thus established from the selected audio signal-carrying device to an ear-mountable speaker of the modular headphone system via the electrical connector. The coupling of the electrical connector with the audio signal-carrying device may include operating a quick disconnect feature of the electrical connector.

According to another implementation, the method further includes disconnecting the electrical connector from the selected audio signal-carrying device, and placing the electrical connector in signal communication with another selected audio signal-carrying device of a different type by coupling the other selected audio signal-carrying device to the electrical connector. In some implementations where the electrical connector includes a quick disconnect feature, the quick disconnect feature may be operated to disconnect the audio signal-carrying device from the electrical connector and couple the other audio signal-carrying device to the electrical connector.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a modular audio system according to various implementations.

FIG. 2 is a schematic view of an example of an electrical conductor that may be utilized in an audio system such as illustrated in FIG. 1.

FIG. 3 is a schematic view of another example of an electrical conductor that may be utilized in an audio system such as illustrated in FIG. 1.

FIG. 4 is a schematic view of an example of an audio system configured by the user such that audio playback may be shared with another user.

FIG. 5 is a schematic view of an example of a wireless interface system that may be utilized in an audio system such as illustrated in FIG. 1.

FIG. 6 is a schematic view of a music/ambient mixing device that may be utilized in an audio system such as illustrated in FIG. 1.

FIG. 7 is a schematic view of a telephonic communication system that may be utilized in an audio system such as illustrated in FIG. 1.

### DETAILED DESCRIPTION

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

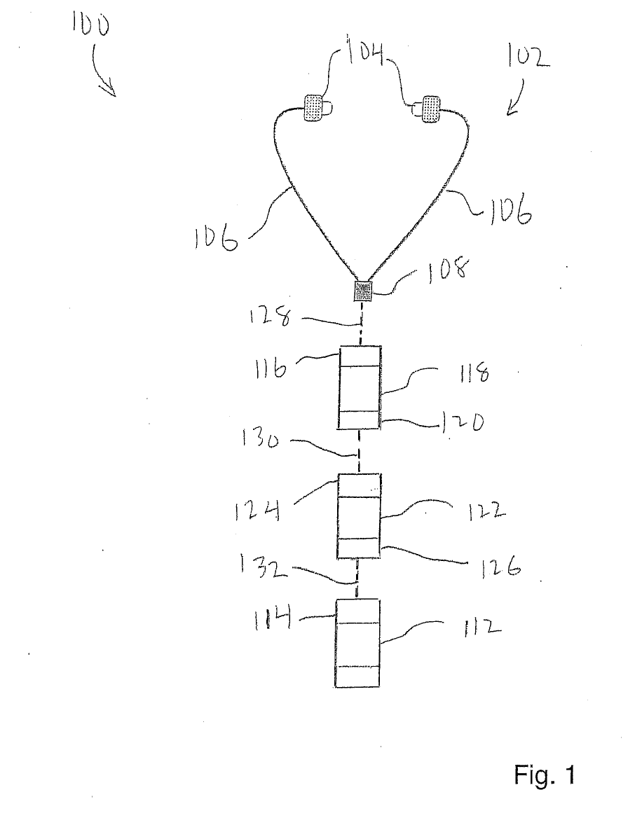

FIG. 1 is a schematic view of an example a modular audio system 100 according to various implementations. The audio system 100 may include a headphone system 102. The headphone system 102 may include one or two ear-mountable speakers 104 of any suitable type (e.g., over-ear, on-ear, in-ear, ear bud or the like). Each ear-mountable speaker 104 provided may electrically communicate with an audio signal conductor (or audio signal-carrying line) 106 of a desired length (e.g., wire, cord, cable, or the like). Each audio signal conductor 106 may electrically communicate with an electrical connector 108 that includes terminals of any suitable design or standard. Electrical communication is thus established between the electrical connector 108 and the ear-mountable speaker 104 by way of the audio signal conductor(s) 106. The headphone system 102 is configured to be quickly and easily connectable or disconnectable from a wide variety of audio-related devices or accessories (generally, audio signal-carrying devices). To this end, the electrical connector 108 may include a quick disconnect feature of any suitable design such as, for example, a positive click lock adapted to engage an audio-related device or accessory, a magnet adapted to couple with another magnet of the audio-related device or accessory, or the like.

In the present example illustrated in FIG. 1, the headphone system 102 may receive an audio signal from an audio source 112. The audio source 112 may be of any type, non-limiting examples of which include various audio playback devices (e.g., CD player, DVD player, MP3 player, tape player, etc.), audio broadcasting or receiver devices (e.g., radio, telephone, television, etc.), microphones, and combinations of two or more of the foregoing. The audio source 112 may be a component of a home theater or entertainment system, a component installed in a computer, a component installed in a vehicle, or a mobile or hand-held device.

In some implementations, the electrical connector 108 of the headphone system 102 may be configured for being coupled directly to a corresponding electrical connector 114 of the audio source 112, in which case audio signals from the audio source 112 are fed directly to the electrical connector 108 of the headphone system 102 through its connection with the corresponding electrical connector 114 of the audio source 112. In this case, the electrical connector 114 of the audio source 112 may be configured to engage with the above-noted quick disconnect feature of the electrical connector 108 of the headphone system 102 to ensure a secure, yet quickly releasable, user-friendly connection.

Additionally or alternatively, the electrical connector 108 may be configured for being coupled to a corresponding electrical connector 116 of an intermediate audio signal-carrying device 118. The audio source 112 may likewise be coupled to another electrical connector 120 of the intermediate audio signal-carrying device 118, in which case audio signals from the audio source 112 are fed to the electrical connector 108 of the headphone system 102 via the intermediate audio signal-carrying device 118. The intermediate audio signal-carrying device 118 may be any audio-related device or accessory now known or later developed. As non-limiting examples, the intermediate audio signal-carrying device 118 may be an electrical conductor of a desired length (e.g., wire, cord, cable, or the like), a signal-splitting device (or splitter jack), a wireless interface, a music/ambient mixing device, a noise canceling device, a microphone line, an adapter providing interface compatibility with the audio source 112, and the like, and combinations of two or more of the foregoing.

Additionally or alternatively, the audio system 100 may include one or more additional intermediate audio signal-carrying devices 122 interposed in signal communication between the headphone system 102 and the audio source 112. The additional intermediate audio signal-carrying device 122 may include an electrical connector 124 adapted for coupling to the first intermediate audio signal-carrying device 118, and another electrical connector 126 adapted for coupling to the audio source 112 or to yet another intermediate audio signal-carrying device (not shown). As non-limiting examples, the intermediate audio signal-carrying device 122 may be an electrical conductor of a desired length (e.g., wire, cord, cable, or the like), a wireless transmitter or dongle, a music/ambient mixing device, a noise canceling device, an adapter of any type that provides compatibility with the audio source 112, and the like, and combinations of two or more of the foregoing.

It will be understood that in FIG. 1, lines 128, 130 and 132 schematically depict electrical (audio signal) communication between two components, and do not necessarily indicate any particular spatial or physical relation between those two components. In an implementation in which the first intermediate audio signal-carrying device 118 is a wireless transmitter and the second intermediate audio signal-carrying device 122 is a wireless receiver, the intervening schematic line 130 may be considered as representing a wireless transmission link over which audio or other electrical signals are carried. In some implementations, the first intermediate audio signal-carrying device 118 and/or the second intermediate audio signal-carrying device 122 may be an integral part of or attached to some other device. In some implementations in which the first intermediate audio signal-carrying device 118 is a wireless transmitter and the second intermediate audio signal-carrying device 122 is a wireless receiver, the first intermediate audio signal-carrying device 118 and/or the second intermediate audio signal-carrying device 122 may be considered as functioning as the electrical connector of an associated device. For example, the second intermediate audio signal-carrying device 122 as a wireless receiver may function as the electrical (i.e., electromagnetic) connector 114, or one of a plurality of available electrical connectors 114, of the audio source 112.

It will also be understood that one or more features or functions noted above as examples for the first intermediate audio signal-carrying device 118 may be combined (added with, integrated with, included with, etc.) one or more features or functions noted above as examples for the second intermediate audio signal-carrying device 122, and/or with one or more features or functions noted above as examples for the audio source 112. In this way, for instance, the number of individual audio signal-carrying devices 112, 118, 122 may be reduced. That is, for example, a single intermediate audio signal-carrying device 118 or 122 that includes a plurality of different functions or features may be coupled to the headphone system 102, thus reducing the number of separate modules needed by the user for configuring the audio system 100 in accordance with the user's desires.

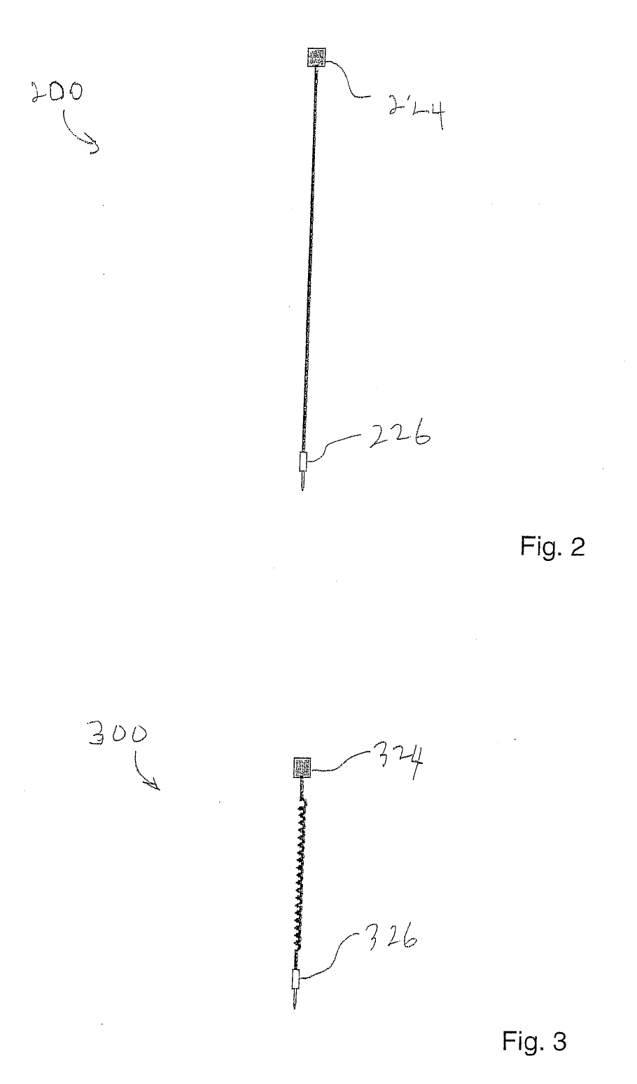

FIG. 2 is a schematic view of an example of an elongated electrical conductor (e.g., wire, cord, cable, or the like) 200 that may be utilized as the sole intermediate audio signal-carrying device 118 or 122 between the headphone system 102 and the audio source 112 illustrated in FIG. 1. Alternatively, depending of the configuration of the audio system 100 selected by the user, the electrical conductor 200 may be utilized as the first intermediate audio signal-carrying device 118 or the second intermediate audio signal-carrying device 122. The electrical conductor 200 at one end may include an electrical connector 224 for coupling directly to the electrical connector 108 of the headphone system 102 or to the electrical connector 120 of another intermediate audio signal-carrying device 118. The electrical conductor 200 at the other end may include an electrical connector 226 for coupling directly to the electrical connector 114 of the audio source 112 or to the electrical connector 124 of another intermediate audio signal-carrying device 122.

FIG. 3 is a schematic view of another example of an elongated electrical conductor (e.g., wire, cord, cable, or the like) 300 that includes opposing electrical connectors 324 and 326. The electrical conductor 300 in this example is coiled rather than straight, but otherwise may be similar to the electrical conductor 200 illustrated in FIG. 2.

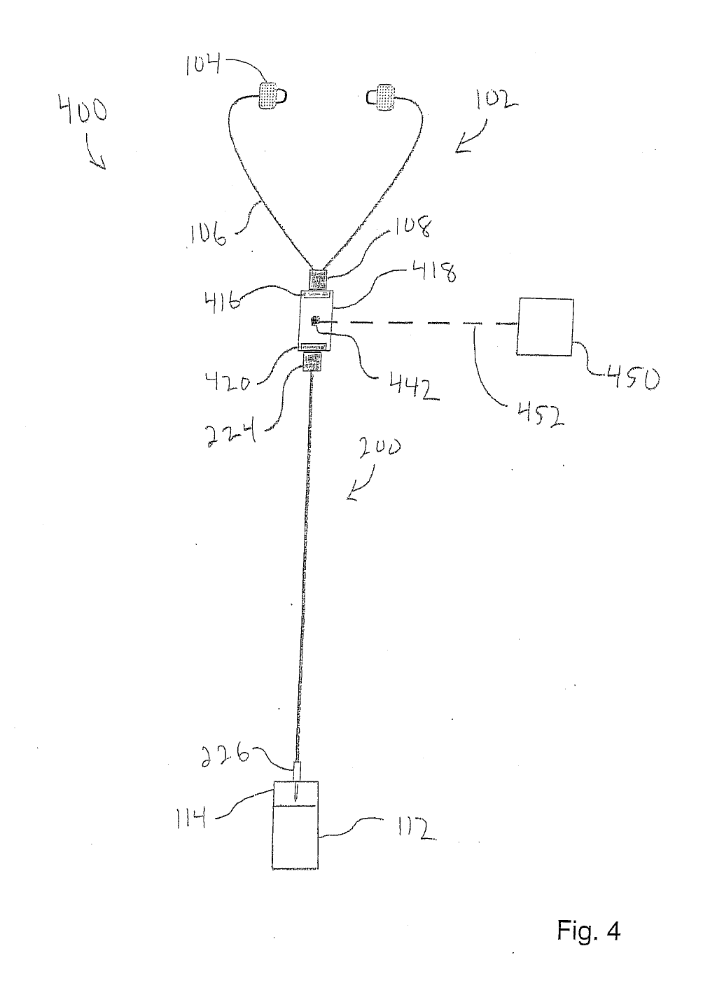

FIG. 4 is a schematic view of an example of an audio system 400 configured by the user such that audio playback may be shared with another user. In this example, a signal splitting device 418 is utilized as a first audio signal-carrying device and the electrical conductor 200 (or 300) is utilized as a second audio signal-carrying device. The signal splitting device 418 includes an electrical connector 416 coupled to the electrical connector 108 of the headphone system 102 and an electrical connector 420 coupled to the electrical connector 224 of the electrical conductor 200. The other electrical connector 226 of the electrical conductor 200 is in turn coupled to the electrical connector 114 of the audio device 112. The signal splitting device 418 additionally includes a third electrical connector 442 (e.g., a receptacle for an input jack). By this configuration, a headphone system 450 of the second user may be placed in signal communication with the audio source 112 of the first user by coupling the headphone system 450 to the signal splitting device 418 via another electrical conductor 452 (removably connected at the third electrical connector 442). The headphone system 450 and the electrical conductor 452 of the second user may be of the same or similar design (or commercially offered product model) as the first headphone system 102 and electrical conductor 200, respectively.

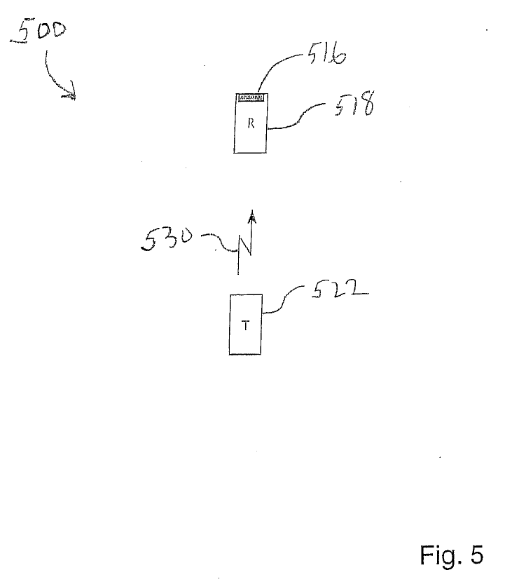

FIG. 5 is a schematic view of an example of a wireless interface system 500. The wireless interface system 500 includes a wireless receiver 518 and a wireless transmitter 522 (or dongle in computer-related applications) communicating over a wireless transmission link 530. The wireless interface system 500 may be utilized as part of the audio system 100 illustrated in FIG. 1 or some other audio system. Accordingly, the wireless receiver 518 may serve as the first audio signal-carrying device 118 and the wireless transmitter 522 may serve as the second audio signal-carrying device 122 illustrated in FIG. 1. Thus, the wireless receiver 518 may include an electrical connector 516 adapted to be coupled to the electrical connector 108 of the headphone system 102. The wireless transmitter 522 may be coupled to the audio source 112 or to some other type of audio-related device. As previously noted, the wireless transmitter 522 may be integrated as a part of the audio source 112 or other audio-related device, and/or may be considered as being an electrical connector of the audio source 112 or other audio-related device. Implementations such as illustrated in FIG. 5 eliminate the need for the elongated electrical conductor 200 or 300 illustrated in FIGS. 2 and 3.

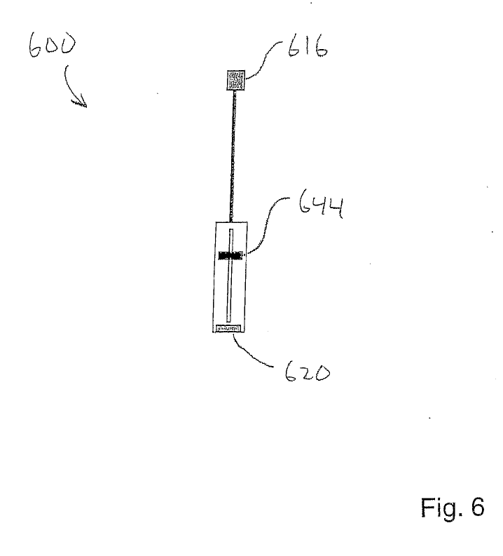

FIG. 6 is a schematic view of a music/ambient mixing device 600 that may likewise be utilized in the audio system 100 illustrated in FIG. 1 or some other audio system. Accordingly, the music/ambient mixing device 600 may serve as the first audio signal-carrying device 118 or the second audio signal-carrying device 122 illustrated in FIG. 1. Thus, the music/ambient mixing device 600 includes electrical connectors 616 and 620 adapted to be coupled to corresponding components of the audio system 100. As an example, the music/ambient mixing device 600 may be interconnected between the headphone system 102 and an elongated electrical conductor 200 (or 300), and the elongated electrical conductor 200 may be coupled to the audio source 112 or other audio-related device. The music/ambient mixing device 600 may include an adjustment feature 644 (e.g., a slider, dial, knob, etc.) that enables the user to adjust the volume of the input audio signal fed from the audio source 112 relative to ambient sound sources (e.g., another person speaking to the user).

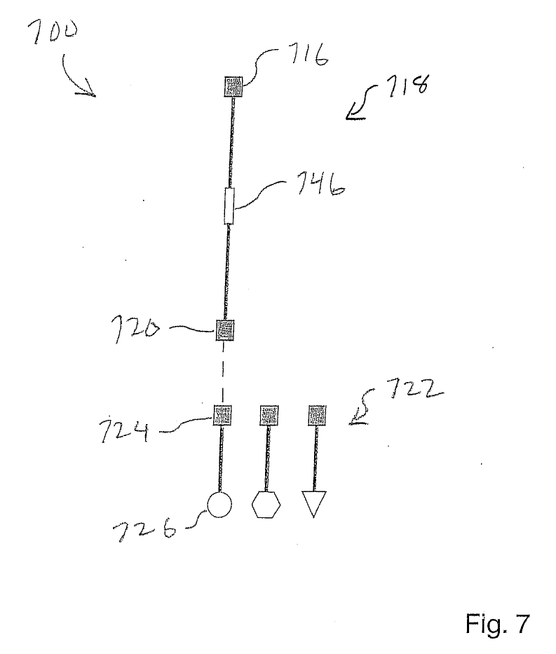

FIG. 7 is a schematic view of a telephonic communication system 700 that may also be utilized in the audio system 100 illustrated in FIG. 1 or some other audio system. In this example, the audio source 112 illustrated in FIG. 1 may be a conventional LAN line-type telephone, a mobile (or cellular) telephone, a telephone integrated with or connected to a computer, or the like. The telephonic communication system 700 may include a microphone line 718 and a brand-specific telephone adapter 722. The microphone line 718 may serve as the first audio signal-carrying device 118 and the telephone adapter 722 may serve as the second audio signal-carrying device 122 illustrated in FIG. 1. Thus, the microphone line 718 may include an electrical connector 716 adapted to be coupled to the electrical connector 108 of the headphone system 102, and an electrical connector 720 adapted to be coupled to a corresponding electrical connector 724 of the telephone adapter 722. Another electrical connector 726 is adapted to be coupled to the telephone (e.g., audio source 112 in FIG. 1). The telephone adapter 722 may be integrated as a part of the telephone. To provide a wide range of compatibility, different types of telephone adapters 722 may be provided, as illustrated in FIG. 7. In some implementations, the telephone adapter 722 is not needed. The microphone line 718 may include a microphone 746. In one example, the microphone line 718 is configured as an elongated electrical conductor with the microphone 746 located in an in-line position. The microphone line 718 may include a momentary switch that enables the user to answer, initiate or terminate a telephone call. In one example, the momentary switch is mounted at or near the microphone 746.

It will be understood that the various devices illustrated by example in FIGS. 2-7 are among a wider range of devices that may be utilized in the audio system 100 illustrated in FIG. 1.

It can be seen from the foregoing description that the headphone system 102 and various implementations of the related audio system 100 provide the user with significant flexibility in selecting how the headphone system 102 is to be employed. Utilizing the same headphone system 102, the user may configure a wide variety of different types of audio systems 100 such as, for example, a system that enables the sharing of audio playback with another user, a wired or wireless audio-related system, a telephony system, among many other configurations. Moreover, the user may easily reconfigure the audio system 100 to implement different functions or services, or switch between different accessories. For example, the user may normally utilize just the electrical conductor 200 (or 300) to conduct audio signals to the headphone system 102 from the audio source 112. The user may then decide to interconnect the signal splitting device 418 between the headphone system 102 and the electrical conductor 200 to allow a second user to plug into the signal splitting device 418 and listen to the audio playback. The user may also decide to convert the audio system 100 from a wired system to a wireless system by substituting the wireless interface system 500 for the electrical conductor 200. In a particular situation such as, for example, traveling or working in an office environment, the user may interconnect the music/ambient mixing device 600 into the audio system 100. As another example, the user may switch from utilizing the headphone system 102 to listen to playback from a CD or MP3 player to utilizing the headphone system 102 for telephone use, by interconnecting the microphone line 718 and, if needed, the telephone adapter 722 into the audio system 100.

All such methods entailing the use or operation of the headphone system 102 are encompassed by the present application.

All of the foregoing methods and configurations may be enhanced or facilitated through the use of the above-described quick disconnect feature of the electrical connector 108 of the headphone system 102.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A modular headphone system, comprising:
an ear-mountable speaker;
an audio signal-carrying line coupled to the ear-mountable speaker; and
an electrical connector coupled to the audio signal-carrying line and configured for electrically coupling to a plurality of different types of audio signal-carrying devices, the electrical connector including a quick disconnect feature configured for securing the electrical connector to the audio signal-carrying device.

2. The modular headphone system of claim 1, where the quick disconnect feature includes a positive click lock.

3. The modular headphone system of claim 1, where the quick disconnect feature includes a magnet configured for coupling to another magnet of another electrical connector.

4. The modular headphone system of claim 1, where at least one of the plurality of audio signal-carrying devices is selected from the group consisting of an audio source, a signal splitting device, a wireless interface, a music/ambient mixing device, a noise cancelling device, a microphone, an elongated conductor including an in-line microphone, an adapter configured for coupling to a telephony device, an elongated electrical conductor including a pair of opposing electrical connectors, and combinations of two or more of the foregoing.

5. A modular audio system, comprising:
a headphone system including an ear-mountable speaker, an audio signal-carrying line coupled to ear-mountable speaker, and an electrical connector coupled to the audio signal-carrying line, the electrical connector including a quick disconnect feature; and
an audio signal-carrying device electrically coupled to the electrical connector and secured to the electrical connector via the quick disconnect feature.

6. The modular audio system of claim 5, where the audio signal-carrying device is an audio source.

7. The modular audio system of claim 6, where the audio source is selected from the group consisting of an audio playback device, an audio receiver device, a telephonic device, a microphone, and combinations of two or more of the foregoing.

8. The modular audio system of claim 5, where the audio signal-carrying device is selected from the group consisting of an audio source, a signal splitting device, a wireless interface, a music/ambient mixing device, a noise cancelling device, a microphone, an elongated conductor including an in-line microphone, an adapter configured for coupling to a telephony device, an elongated electrical conductor including a pair of opposing electrical connectors, and combinations of two or more of the foregoing.

9. The modular audio system of claim 5, further including an audio source coupled to the audio signal-carrying device, where the audio source is in signal communication with the electrical connector of the headphone system via the audio signal-carrying device.

10. The modular audio system of claim 5, where the audio signal-carrying device coupled to the electrical connector of the headphone system is a first audio signal-carrying device, and further including a second audio signal-carrying device electrically coupled to the first audio signal-carrying device.

11. The modular audio system of claim 10, where:
the first audio signal-carrying device is selected from the group consisting of a signal splitting device, a wireless receiver, a music/ambient mixing device, a noise cancelling device, a microphone, an elongated conductor including an in-line microphone, an elongated electrical conductor including a pair of opposing electrical connectors, and combinations of two or more of the foregoing; and
the second audio signal-carrying device is selected from the group consisting of an audio source, a signal splitting device, a wireless transmitter, a music/ambient mixing device, a noise cancelling device, a microphone, an elongated conductor including an in-line microphone, an adapter configured for coupling to a telephony device, an elongated electrical conductor including a pair of opposing electrical connectors, and combinations of two or more of the foregoing.

12. The modular audio system of claim 10, where the first audio signal-carrying device is an elongated electrical conductor and the second audio signal-carrying device is an audio source.

13. The modular audio system of claim 10, where at least one of the first and second audio signal-carrying devices is a signal splitting device, and at least one of the first and second audio signal-carrying devices is an elongated electrical conductor.

14. The modular audio system of claim 10, where the first audio signal-carrying device is a wireless receiver and the second audio signal-carrying device is a wireless transmitter.

15. The modular audio system of claim 10, where at least one of the first and second audio signal-carrying devices is a music/ambient mixing device or a noise cancelling device, and at least one of the first and second audio signal-carrying devices is an elongated electrical conductor.

16. The modular audio system of claim 10, where the first audio signal-carrying device is a microphone and the second audio signal-carrying device is an adapter configured for coupling to a telephony device.

17. The modular audio system of claim 10, further including an audio source coupled to the second audio signal-carrying device.

18. A method for coupling a modular headphone system to an audio signal-carrying device, the method comprising:
selecting an audio signal-carrying device from one of a plurality of different types of audio signal-carrying devices; and
placing an electrical connector of the modular headphone system in signal communication with the selected audio signal-carrying device by coupling the selected audio signal-carrying device to a quick disconnect feature of the electrical connector, where signal communication is established from the selected audio signal-carrying device to an ear-mountable speaker of the modular headphone system via the electrical connector.

19. The method of claim 18, where coupling the selected audio signal-carrying device to the quick disconnect feature includes operating a positive click lock of the quick disconnect feature.

20. The method of claim 18, where coupling the selected audio signal-carrying device to the quick disconnect feature includes coupling a magnet of the quick disconnect feature to a magnet of another electrical connector communicating with the selected audio source.

21. The method of claim 18, where the audio signal-carrying device is an audio source selected from the group consisting of an audio playback device, an audio receiver device, a telephonic device, a microphone, and combinations of two or more of the foregoing.

22. The method of claim 18, where the audio signal-carrying device is selected from the group consisting of an audio source, a signal splitting device, a wireless interface, a music/ambient mixing device, a noise cancelling device, a microphone, an elongated conductor including an in-line microphone, an adapter configured for coupling to a telephony device, an elongated electrical conductor including a pair of opposing electrical connectors, and combinations of two or more of the foregoing.

23. The method of claim 18, where the selected audio signal-carrying device coupled to the electrical connector of the headphone system is a first audio signal-carrying device, and further including coupling a second audio signal-carrying device to the first audio signal-carrying device.

24. The method of claim 23, where:
the first audio signal-carrying device is selected from the group consisting of a signal splitting device, a wireless receiver, a music/ambient mixing device, a noise cancelling device, a microphone, an elongated conductor including an in-line microphone, an elongated electrical conductor including a pair of opposing electrical connectors, and combinations of two or more of the foregoing; and
the second audio signal-carrying device is selected from the group consisting of an audio source, a signal splitting device, a wireless transmitter, a music/ambient mixing device, a noise cancelling device, a microphone, an elongated conductor including an in-line microphone, an adapter configured for coupling to a telephony device, an elongated electrical conductor including a pair of opposing electrical connectors, and combinations of two or more of the foregoing.

25. The method of claim 23, further including coupling an audio source to the second audio signal-carrying device.

26. The method of claim 18, further including disconnecting the electrical connector from the selected audio signal-carrying device, and placing the electrical connector in signal communication with another selected audio signal-carrying device of a different type by coupling the other selected audio signal-carrying device to the quick disconnect feature.
